(19) United States
(12) Patent Application Publication
(10) Pub. No.: US 2006/0182888 A1
(43) Pub. Date: Aug. 17, 2006

(54) Modifying steel surfaces to mitigate fouling and corrosion

(76) Inventors: Ian A. Cody, Baton Rouge, LA (US); Thomas Bruno, Raritan, NJ (US); Hyung S. Woo, Baton Rouge, LA (US); H. Alan Wolf, Morristown, NJ (US); Glen B. Brons, Phillipsburg, NJ (US); Steve G. Colgrove, Baton Rouge, LA (US); LeRoy R. Clavenna, Baton Rouge, LA (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/304,875

(22) Filed: Dec. 15, 2005

Related U.S. Application Data
(63) Continuation of application No. 60/642,674, filed on Jan. 10, 2005.

(51) Int. Cl. B05D 3/02

(52) U.S. Cl. 427/314

(57) ABSTRACT

This invention relates to a method for making a carbon steel surface more resistant to fouling and corrosion by subjecting a cleaned carbon steel surface to heating in an oxygen-containing atmosphere followed by exposure of the heated surface to sulfur-containing feeds such that a dense layer of Fe₁₋ₓ S where X is a number from 0.2 to 0.0 is formed on the steel surface, said dense layer having a thickness of from 0.5 to 200 microns.

### CROSS REFERENCE TO RELATED APPLICATION

This application claims benefit of U.S. Provisional Patent Application Ser. No. 60/642,674 filed Jan. 10, 2005.

### FIELD OF THE INVENTION

This invention relates to a method for making a steel surface more resistant to fouling and corrosion. More particularly, the steel is subjected to heating in an oxygen-containing atmosphere followed by exposure of the treated surface to sulfur-containing feeds such that a dense iron sulfide layer is formed on the steel surface.

### BACKGROUND OF THE INVENTION

Fouling of metal surfaces such as the piping, heat exchangers and reactors used in refineries and chemical plants result in significant costs including cleaning and equipment down times. Such fouling can occur from a number of sources such as crudes, distillates, process feedstocks and the like. In many instances, costs may also include energy costs associated with more extreme operating conditions necessitated by the presence of foulants such as coke and attendant safety issues. For petroleum refiners, the costs associated with cleaning and equipment down times can run into annual costs in the hundreds of millions of dollars range.

There have been a number of approaches to mitigating fouling including coatings for metal surfaces. One approach for forming a protective surface film is by depositing a layer of silica resulting from thermal decomposition of an alkoxy silane in the vapor phase on the metal surface. Another approach is to passivate a reactor surface subject to coking by coating the reactor surface with a thin layer of a ceramic material deposited by thermal decomposition of a silicon containing precursor in the vapor phase. Other coatings are directed to polymeric materials. Another approach to mitigating coke formation is to treat a de-coked metal surface with sulfur-containing chemicals such as dimethylsulfide or dimethyldisulfide and a silicon-containing chemical. This creates a sulfur treated metal surface coated with a silica layer.

In many petroleum applications, deposits of iron sulfide scale are considered as contaminants which should be removed, particularly where catalysts are involved. Such scale can be removed using high-temperature steam and/or oxygen-containing gas.

Physical cleaning by hydroblasting or steam injection has been used to clean fouled equipment. Chemical mitigation can also be employed. This typically involves the use of anti-foulants to remove or minimize creation of unwanted deposits. Examples of such anti-foulants include sulfur- and phosphorus-containing compounds and phenolic compounds.

The typical coatings for industrial conduits are generally in the micron to millimeter range in thickness. This is usually to ensure good surface coverage as well as provide a protective layer of sufficient thickness to be robust during operating conditions.

It would be desirable to have a protective coating for refinery and chemical process equipment including piping and heat exchangers which can be created in-situ on metal surfaces without the need of added chemical modifiers for creating a protected surface.

### SUMMARY OF THE INVENTION

This invention relates to a process for protecting clean steel including low alloy steel from corrosion and fouling which comprises: heating the clean steel that is initially substantially free of carbonaceous deposits in the presence of an oxygen-containing gas at temperatures from 200 to 500° C. to produce a treated steel, and contacting the treated steel with a sulfur-containing crude or sulfur-containing fraction thereof at a temperature of from 100 to 450° C., wherein a dense phase contiguous layer of Fe₁₋ₓ S where X is a number from 0.2 to 0.0, said dense phase layer having a thickness of from 0.5 to 200 microns.

In another embodiment, steel including low alloy steel that has been contaminated with carbonaceous deposits is protected from fouling by a process comprising: cleaning fouled steel by removing the carbonaceous deposits to produce a clean steel that is substantially free of carbonaceous deposits, heating clean steel in the presence of an oxygen-containing gas at temperatures from 200 to 500° C. to produce a treated steel, and contacting the treated steel with a sulfur-containing crude or sulfur-containing fraction thereof at a temperature of from 100 to 450° C., wherein a dense phase contiguous layer of Fe₁₋ₓ S where X is a number from 0.2 to 0.0, said dense phase layer having a thickness of from 0.5 to 200 microns.

### BRIEF DESCRIPTION OF THE DRAWINGS

FIG. 1 is a photograph of steel rods that have not been air heated vs. air heated carbon steel rods.

FIGS. 2A and 2B are scanning electron micrographs of untreated steel rod vs. steel rod that has been air heated.

### DETAILED DESCRIPTION OF THE INVENTION

In a typical petroleum refinery or chemical plant, conduits, reactors and other equipment handling feedstocks with sulfur-contaminants form carbonaceous and iron sulfide scale deposits at operating temperatures. Such fouling deposits must be periodically removed to restore efficient operating conditions to the equipment handling the feedstocks. Fouled equipment is normally cleaned by taking the equipment off-line followed by sand or steam blasting.

In the present invention, process equipment made of steel that is new or has been cleaned by conventional means such as sand or steam blasting such that the surface is substantially clean of carbonaceous deposits is heated at temperatures of from 200 to 500° C., preferably from 250 to 400° C. in the presence of oxygen-containing gas followed by contacting the heated steel with sulfur-containing feedstock at temperatures of from 100 to 450° C., preferably from 250 to 400° C. The sulfur-containing feedstock may be pre-heated. By “substantially free of carbonaceous deposits” means that the surface contains less than 20% carbon deposits, as measured by x-ray photoelectron spectroscopy. The steel is preferably carbon steel. The term steel also includes low alloy steels such as those containing small amounts of Cr and/or Mo.

Conventional cleaning of fouled equipment typically involves removal of foulants by mechanical scouring, by high pressure water or steam washing, or some combination thereof. Mechanical scouring is normally done by sand blasting or some other form of grit blasting.

Once the equipment is clean, it is heated in the presence of an oxygen-containing gas as noted above. The oxygen-containing gas may be air or inert gas having an oxygen content sufficient to form an oxide coating. Air is the preferred oxygen-containing gas. The steel surface that has been heated in the presence of oxygen is believed to form a surface iron oxide coating. The iron oxide layer has a high surface free energy. By high surface free energy is meant that the surface energy is greater than 100 milliJoules/square meter (mJ/m²), preferably greater than 500 mJ/m².

The hot, treated steel is then contacted with a sulfur-containing feed. The sulfur-containing feed should have a sulfur content greater than about 0.5 wt. %, based on feed, preferably greater than 1 wt. %. The type of sulfur-containing feed is preferably related to the service of the steel equipment. For example, steel equipment in contact with crude, e.g., crude pipelines, pre-heaters and heat exchangers would normally be contacted with sulfur-bearing crude. Steel equipment in contact with distillate fractions or bottoms fraction would be contacted with sulfur-containing distillate or bottoms fractions. However, the type of sulfur-containing feed used to contact the cleaned steel contacted with oxygen-containing gas is not critical so long as the feed has sufficient sulfur-content to provide the iron sulfide protective coating according to the invention.

The iron sulfide protective layer is deposited on the cleaned steel contacted with oxygen-containing gas by contacting with sulfur-containing feed. The protective iron sulfide layer has a thickness of from 0.5 to 200 microns, preferably from 1 to 10 microns. The iron sulfide may have the formula Fe₁₋ₓ S where X is a number from 0.2 to 0.0, preferably 0.1 to 0.0.

The formation of dense iron sulfide protective layer is further illustrated in the following example.

### EXAMPLE

An Alcor pilot unit manufactured by Alcor instruments of Texas was used to examine heat exchange performance of various iron surfaces, including 1018 carbon steel, A304 stainless steel and surface modified forms of the 1018 carbon steels. The Alcor HLPS-400 Liquid Process Simulator provides an accurate, yet easy-to-use tool for predicting heat exchanger performance and the fouling tendencies of specific process fluids. The HLPS combines various system elements—temperature, pressure, and variable flow—to study thermal degradation.

Temperature, pressure and flow rate are variable up to 650° C. (1200° F.), 59 MPa (850 psig) and 5 ml/min respectively. These variables may be independently adjusted and controlled to allow simulation of an extensive range of process conditions. The basic system consists of a sample reservoir, a heat exchanger test section, and a constant displacement pump located downstream of the test section. Typical test run time is for three hours. Tests are carried out by charging a reservoir with up to 800 ml of test fluid. The fluid in the reservoir and lines to and from the test heat exchanger are typically heated to 150° C. (200° C. maximum). To prevent vaporization to the test fluid, the system is pressurized to typically 500 psig with nitrogen. The fluid from the reservoir is pulled through the test heat exchanger at a flow rate of typically 3 ml/min by a downstream pump. The pump returns the fluid to the top of the reservoir. A piston is placed in the reservoir to separate the new sample from the tested sample. In the test heat exchanger, the fluid flows through an annulus formed by a vertically positioned heater rod test coupon. The heater rod is electrically isolated from the outer shell, and the rod is heated by passing an electrical current through it. The test section of the heater rod is about 3.20 mm in outside diameter and 60 mm long. The outer shell of the test heat exchanger has an about 5.10 mm inside diameter forming about a 0.95 mm annular space for flow. Temperature of the heater rod is controlled by a thermocouple located inside the heater rod test section. Heater rod temperatures tested are typically between 350° C. and 500° C. The temperature of the fluid to the inlet and from the outlet of the heat exchanger is recorded over the duration of the test. As deposits or fouling material build up on the surface of the heater rod, the outlet temperature of fluid from the heat exchanger decreases. This decrease is due to the insulating nature of the deposit on the rod. The decrease in outlet temperature (delta T) gives a measure of the fouling tendency of the carbonaceous deposits on the rod surface.

Feed to the unit was a blend of two whole crudes (70/30 Olmeca/Maya).

Although differences in heat exchange were not evident in this low flow laminar regime, (all rods showed similar delta T profiles with time), there were notable differences in the nature of deposits formed on the rods, depending on their pre-treatment history.

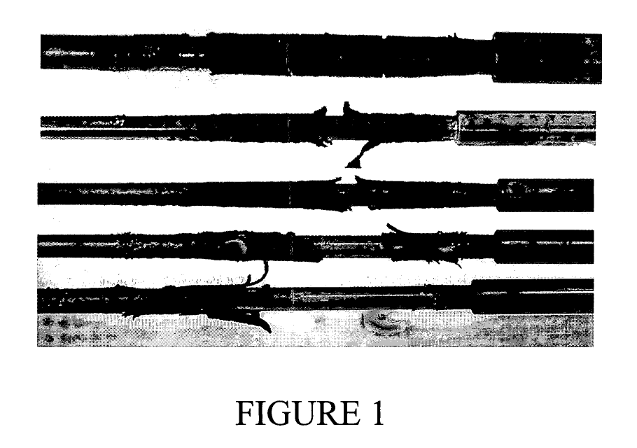

FIG. 1 shows the deposits formed on 1018 carbon steel, on A304 stainless steel, on a 1018 carbon steel with a commercially available coating (Sulfinert, an amorphous silicon coating) and, illustrating the invention, two 1018 carbon steel rods that had been first air heated at 350° C. for one hour and the other heated at 300° C. for one hour. The two air heated rods are distinct in that the carbonaceous deposits were easily shed, following cool down and a simple toluene wash, revealing a shiny, smooth underlying surface. On each of the other rods, the deposits remained strongly adhered.

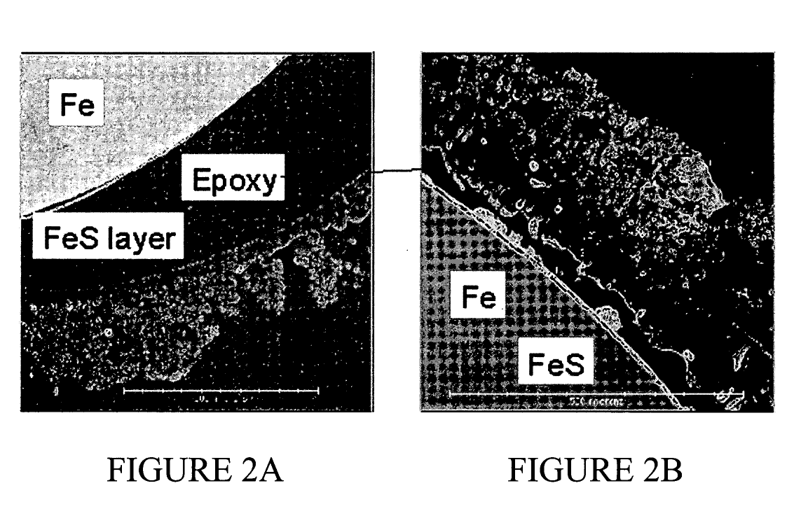

FIGS. 2a and 2b show two Scanning Electron Micrographs of cross-sections of the untreated 1018 carbon steel (right photo) and a 1018 carbon steel that had been air heated prior to exposure to crude (left photo). The air heated rod has a well defined adhered “ribbon” of a dense phase iron sulfide whereas the untreated rod shows “swirls” of iron sulfide that are not well adhered to the iron surface.

It is believed that the strongly bound, thin (about one micron) layer of dense phase Fe₁₋ₓ S creates an effective boundary against further corrosion and helps to minimize the strong adherence of carbonaceous deposits. It is believed that had the experiment been conducted in a higher flow regime, more typical of plant scale heat exchangers, the deposits would not have adhered to the created Fe₁₋ₓ S surface.

1. A process for protecting clean steel including low alloy steel from corrosion and fouling which comprises: heating the clean steel that is initially substantially free of carbonaceous deposits in the presence of an oxygen-containing gas at temperatures from 200 to 500° C. to produce a treated steel, and contacting the treated steel with a sulfur-containing crude or sulfur-containing fraction thereof at a temperature of from 100 to 450° C., wherein a dense phase contiguous layer of Fe₁₋ₓ S where X is a number from 0.2 to 0.0, said dense phase layer having a thickness of from 0.5 to 200 microns.

2. A process for protecting steel including low alloy steel that has been contaminated with carbonaceous deposits from fouling and corrosion which comprises: cleaning contaminated steel by removing the carbonaceous deposits to produce a clean steel that is substantially free of carbonaceous deposits, heating clean steel in the presence of an oxygen-containing gas at temperatures from 200 to 500° C. to produce a treated steel, and contacting the treated steel with a sulfur-containing crude or sulfur-containing fraction thereof at a temperature of from 100 to 450° C., wherein a dense phase contiguous layer of Fe₁₋ₓ S where X is a number from 0.2 to 0.0, said dense phase layer having a thickness of from 0.5 to 200 microns.

3. The process of claims 1 or 2 wherein the steel is carbon steel.

4. The process of claims 1 or 2 wherein the low alloy steel contains at least one of Cr or Mo.

5. The process of claims 1 or 2 wherein the oxygen-containing gas is air.

6. The process of claims 1 or 2 wherein the sulfur-containing crude or sulfur-containing fraction thereof has a sulfur content greater than about 0.5 wt. %, based on feed.

7. The process of claims 1 or 2 wherein the clean steel that is substantially free of carbonaceous deposits has a surface that contains less than 20% carbon deposits.

8. The process of claims 1 or 2 wherein the treated steel has a surface oxide coating having a high surface free energy.

9. The process of claim 8 wherein the high surface free energy is greater than 100 milliJoules/square meter (mJ/m²).
